(19) United States
(12) Patent Application Publication
(10) Pub. No.: US 2025/0192582 A1
(43) Pub. Date: Jun. 12, 2025

(54) APPARATUS FOR PROTECTING VEHICLE BATTERY AND METHOD THEREOF

(71) Applicants: Hyundai Motor Company, Seoul (KR); Kia Corporation, Seoul (KR); Yura Corporation Co., Ltd., Seongnam-si (KR)

(72) Inventors: Hee Gun Yang, Seongnam-si (KR); Kang Woo Bae, Suwon-si (KR); Sung In Baek, Hwaseong-si (KR); Chan Young Jung, Yongin-si (KR); Joon Tae Jang, Hwaseong-si (KR)

(21) Appl. No.: 18/807,377

(22) Filed: Aug. 16, 2024

(30) Foreign Application Priority Data
Dec. 8, 2023 (KR) 10-2023-0178069

(51) Int. Cl. H02J 7/00; B60L 58/14; B60L 58/15

(52) U.S. Cl. CPC H02J 7/0031; B60L 58/14; B60L 58/15; H02J 7/00308; H02J 7/007182; B60L 2210/10

(57) ABSTRACT

An embodiment apparatus for protecting a battery of a vehicle includes a latch relay configured to electrically connect or disconnect the battery and a converter in the vehicle and a controller configured to be activated by a voltage input to the latch relay and a voltage output from the latch relay, detect a failure of the battery based on a reference voltage generated by a low dropout regulator, and control the latch relay to electrically disconnect the battery and the converter in response to detection of the failure of the battery.

### CROSS-REFERENCE TO RELATED APPLICATIONS

This application claims the benefit of Korean Patent Application No. 10-2023-0178069, filed on Dec. 8, 2023, which application is hereby incorporated herein by reference.

### TECHNICAL FIELD

The present disclosure relates to an apparatus for protecting a vehicle battery and a method thereof.

### BACKGROUND

Generally, a battery pack used in an energy storage system (ESS) or an electric vehicle (EV) includes a preset number of groups in which a plurality of battery cells are connected in parallel to each other to increase current capacity and has a structure in which the groups are connected in series to each other to output a rated voltage.

In this case, the battery cell includes a cathode current collector, an anode current collector, a separator, an active material, an electrolyte, and the like and can be repeatedly charged and discharged through electrochemical reactions between components. In order to protect the plurality of battery cells from external shocks such as heat, vibration, and the like, a battery module may be formed by combining the plurality of battery cells into one. In order to systematically manage a plurality of battery modules, a battery pack (i.e., a battery system) may be formed by using the plurality of battery modules, a battery management system (BMS), and a cooling device.

The BMS may include a battery monitoring IC (BMIC) and a micro controller unit (MCU). In this case, the BMIC may periodically monitor battery failure and transmit a fault signal (or message) to the MCU when a failure occurs in the battery. The MCU can receive a fault signal from the BMIC, determine the type of battery failure through serial peripheral interface (SPI) communication with the BMIC, and protect the battery by turning off the latch relay.

However, when one of the BMIC and MCU fails or the MCU is in a sleep state, because the BMS not only may not determine battery failure, but also may not turn off the latch relay, it is impossible to prevent thermal runaway of the battery.

Therefore, an additional scheme is required to turn off the latch relay even when one of the BMIC and the MCU fails or the MCU is in a sleep state.

The matters described in this background section are intended to promote an understanding of the background of the disclosure and may include matters that are not already known.

### SUMMARY

The present disclosure relates to an apparatus for protecting a vehicle battery and a method thereof. Particular embodiments relate to a technology for protecting a battery by turning off a latch relay located between the battery and a low voltage DC-DC converter (LDC) when a failure occurs in the battery of a vehicle.

Embodiments of the present disclosure can solve problems occurring in the prior art while advantages achieved by the prior art are maintained intact.

An embodiment of the present disclosure provides an apparatus for protecting a vehicle battery that includes a latch relay that electrically connects or disconnects the vehicle battery and a low voltage DC-DC converter (LDC), is activated by the voltage input to the latch relay and the voltage output from the latch relay, and detects a failure of the battery based on a reference voltage output from a low dropout (LDO) regulator, such that the apparatus may monitor the state of the battery even when a battery monitoring IC (BMIC) or a micro controller unit (MCU) provided in the vehicle is in a sleep state and may turn off the latch relay when a failure occurs in the battery, and a method thereof.

Another embodiment of the present disclosure provides an apparatus for protecting a vehicle battery that includes a latch relay that electrically connects or disconnects the vehicle battery and an LDC, is activated by the voltage input to the latch relay and the voltage output from the latch relay, and detects an overvoltage or an undervoltage of the battery based on the voltage of the battery and a reference voltage output from the LDO regulator, such that the apparatus may monitor the state of the battery even when a BMIC or a MCU provided in the vehicle is in a sleep state and may turn off the latch relay when a failure occurs in the battery, and a method thereof.

Still another embodiment of the present disclosure provides an apparatus for protecting a vehicle battery that includes a latch relay that electrically connects or disconnects the vehicle battery and an LDC, is activated by the voltage input to the latch relay and the voltage output from the latch relay, determines a converted voltage corresponding to an amount of discharge current of the battery, and detects overdischarge of the battery based on the converted voltage and the reference voltage output from the LDO regulator, such that the apparatus may monitor the state of the battery even when a BMIC or a MCU provided in the vehicle is in a sleep state and may turn off the latch relay when a failure occurs in the battery, and a method thereof.

Still another embodiment of the present disclosure provides an apparatus for protecting a vehicle battery that includes a latch relay that electrically connects or disconnects the vehicle battery and an LDC, is activated by the voltage input to the latch relay and the voltage output from the latch relay, determines a converted voltage corresponding to an amount of charge current of the battery, and detects overcharge of the battery based on the converted voltage and the reference voltage output from the LDO regulator, such that the apparatus may monitor the state of the battery even when a BMIC or a MCU provided in the vehicle is in a sleep state and may turn off the latch relay when a failure occurs in the battery, and a method thereof.

Still another embodiment of the present disclosure provides an apparatus for protecting a vehicle battery that includes a latch relay that electrically connects or disconnects the vehicle battery and an LDC, is activated by a fault signal output from a BMIC provided in a vehicle, and detects a failure of the battery based on the reference voltage output from a LDO regulator, such that the apparatus may monitor the state of the battery even when a failure occurs in the BMIC or MCU or a failure occurs in communication between the BMIC and MCU and may turn off the latch relay when a failure occurs in the battery, and a method thereof.

Still another embodiment of the present disclosure provides an apparatus for protecting a vehicle battery that includes a latch relay that electrically connects or disconnects the vehicle battery and an LDC, is activated by a fault signal output from a BMIC provided in a vehicle, and detects an overvoltage or an undervoltage of the battery based on the voltage of the battery and the reference voltage output from a LDO regulator, such that the apparatus may monitor the state of the battery even when a failure occurs in the BMIC or the MCU or a failure occurs in communication between the BMIC and the MCU and may turn off the latch relay when a failure occurs in the battery, and a method thereof.

Still another embodiment of the present disclosure provides an apparatus for protecting a vehicle battery that includes a latch relay that electrically connects or disconnects the vehicle battery and an LDC, is activated by a fault signal output from a BMIC provided in a vehicle, determines a converted voltage corresponding to the amount of discharge current of the battery, and detects an overdischarge of the battery based on the converted voltage and the reference voltage output from a LDO regulator, such that the apparatus may monitor the state of the battery even when a failure occurs in the BMIC or the MCU or a failure occurs in communication between the BMIC and the MCU and may turn off the latch relay when a failure occurs in the battery, and a method thereof.

Still another embodiment of the present disclosure provides an apparatus for protecting a vehicle battery that includes a latch relay that electrically connects or disconnects the vehicle battery and an LDC, is activated by a fault signal output from a BMIC provided in a vehicle, determines a converted voltage corresponding to the amount of charge current of the battery, and detects an overcharge of the battery based on the converted voltage and the reference voltage output from the LDO regulator, such that the apparatus may monitor the state of the battery even when a failure occurs in the BMIC or the MCU or a failure occurs in communication between the BMIC and the MCU and may turn off the latch relay when a failure occurs in the battery, and a method thereof.

The technical problems solvable by embodiments of the present disclosure are not limited to the aforementioned problems, and any other technical problems not mentioned herein will be clearly understood from the following description by those skilled in the art to which the present disclosure pertains. Also, it may be easily understood that the objects and advantages of embodiments of the present disclosure may be realized by the units and combinations thereof recited in the claims.

According to an embodiment of the present disclosure, an apparatus for protecting a vehicle battery includes a latch relay that electrically connects or disconnects the battery and a converter provided in a vehicle and a controller that is activated by a voltage input to the latch relay and a voltage output from the latch relay, detects a failure of the battery based on a reference voltage generated by a low dropout (LDO) regulator, and controls the latch relay to electrically disconnect the battery and the converter when the failure occurs in the battery.

According to an embodiment, the controller may detect an overvoltage or an undervoltage of the battery based on the reference voltage and a voltage of the battery.

According to an embodiment, the controller may include a reference voltage output device that is activated by the voltage input to the latch relay and the voltage output from the latch relay and outputs the reference voltage, a divider that distributes a portion of the reference voltage as a first reference voltage, an overvoltage detector that compares the first reference voltage and the voltage of the battery and outputs a low signal when the voltage of the battery is higher than the first reference voltage, a switch that is turned on by the low signal to output a high signal, a pulse generator that generates a high pulse for a preset time, and a driver that is driven for a preset time to turn off the latch relay.

According to an embodiment, the controller may include a reference voltage output device that is activated by the voltage input to the latch relay and the voltage output from the latch relay and outputs the reference voltage, a divider that distributes a portion of the reference voltage as a first reference voltage, an undervoltage detector that compares the first reference voltage and the voltage of the battery and outputs a low signal when the voltage of the battery is lower than the first reference voltage, a switch that is turned on by the low signal to output a high signal, a pulse generator that receives the high signal to generate a high pulse for a preset time, and a driver that is driven for a preset time to turn off the latch relay.

According to an embodiment, the controller may determine a converted voltage corresponding to an amount of discharge current of the battery and detect overdischarge of the battery based on the reference voltage and the converted voltage.

According to an embodiment, the controller may include a reference voltage output device that is activated by the voltage input to the latch relay and the voltage output from the latch relay and outputs the reference voltage, a divider that distributes a portion of the reference voltage as a first reference voltage, a differential amplifier that determines the converted voltage corresponding to the amount of the discharge current of the battery, an overdischarge detector that compares the first reference voltage and the converted voltage and outputs a low signal when the converted voltage is greater than the first reference voltage, a switch that is turned on by the low signal to output a high signal, a pulse generator that receives the high signal to generate a high pulse for a preset time, and a driver that is driven for a preset time to turn off the latch relay.

According to an embodiment, the controller may determine a converted voltage corresponding to an amount of charge current of the battery and detect overcharge of the battery based on the reference voltage and the converted voltage.

According to an embodiment, the controller may include a reference voltage output device that is activated by the voltage input to the latch relay and the voltage output from the latch relay and outputs the reference voltage, a divider that distributes a portion of the reference voltage as a first reference voltage, a differential amplifier that determines the converted voltage corresponding to the amount of the charge current of the battery, an overcharge detector that compares the first reference voltage and the converted voltage and outputs a low signal when the converted voltage is lower than the first reference voltage, a switch that is turned on by the low signal to output a high signal, a pulse generator that receives the high signal to generate a high pulse for a preset time, and a driver that is driven for a preset time to turn off the latch relay.

According to another embodiment of the present disclosure, an apparatus for protecting a vehicle battery includes a latch relay that electrically connects or disconnects the battery and a converter provided in a vehicle and a controller that is activated by a fault signal output from a BMIC, detects a failure of the battery based on a reference voltage generated by an LDO regulator, and controls the latch relay to electrically disconnect the battery and the converter when a failure occurs in the battery.

According to an embodiment, the controller may detect an overvoltage or an undervoltage of the battery based on the reference voltage and a voltage of the battery.

According to an embodiment, the controller may include a reference voltage output device that is activated by a voltage input to the latch relay and a voltage output from the latch relay and outputs the reference voltage, a divider that distributes a portion of the reference voltage as a first reference voltage, an overvoltage detector that compares the first reference voltage and the voltage of the battery and outputs a low signal when the voltage of the battery is higher than the first reference voltage, a switch that is turned on by the low signal to output a high signal, a pulse generator that generates a high pulse for a preset time, and a driver that is driven for a preset time to turn off the latch relay.

According to an embodiment, the controller may include a reference voltage output device that is activated by a voltage input to the latch relay and the voltage output from the latch relay and outputs the reference voltage, a divider that distributes a portion of the reference voltage as a first reference voltage, an undervoltage detector that compares the first reference voltage and the voltage of the battery and outputs a low signal when the voltage of the battery is lower than the first reference voltage, a switch that is turned on by the low signal to output a high signal, a pulse generator that receives the high signal to generate a high pulse for a preset time, and a driver that is driven for a preset time to turn off the latch relay.

According to an embodiment, the controller may determine a converted voltage corresponding to an amount of discharge current of the battery and detect overdischarge of the battery based on the reference voltage and the converted voltage.

According to an embodiment, the controller may include a reference voltage output device that is activated by a voltage input to the latch relay and a voltage output from the latch relay and outputs the reference voltage, a divider that distributes a portion of the reference voltage as a first reference voltage, a differential amplifier that determines the converted voltage corresponding to the amount of the discharge current of the battery, an overdischarge detector that compares the first reference voltage and the converted voltage and outputs a low signal when the converted voltage is greater than the first reference voltage, a switch that is turned on by the low signal to output a high signal, a pulse generator that receives the high signal to generate a high pulse for a preset time, and a driver that is driven for a preset time to turn off the latch relay.

According to an embodiment, the controller may determine a converted voltage corresponding to an amount of charge current of the battery and detect overcharge of the battery based on the reference voltage and the converted voltage.

According to an embodiment, the controller may include a reference voltage output device that is activated by a voltage input to the latch relay and a voltage output from the latch relay and outputs the reference voltage, a divider that distributes a portion of the reference voltage as a first reference voltage, a differential amplifier that determines the converted voltage corresponding to the amount of the charge current of the battery, an overcharge detector that compares the first reference voltage and the converted voltage and outputs a low signal when the converted voltage is lower than the first reference voltage, a switch that is turned on by the low signal to output a high signal, a pulse generator that receives the high signal to generate a high pulse for a preset time, and a driver that is driven for a preset time to turn off the latch relay.

According to still another embodiment of the present disclosure, a method of protecting a vehicle battery includes activating a controller by a voltage input to a latch relay and a voltage output from the latch relay or a fault signal output from a BMIC and detecting, by the controller, a failure of the battery based on a reference voltage generated by an LDO regulator, and controlling the latch relay to electrically disconnect the battery and a converter when a failure occurs in the battery.

According to an embodiment, the controlling of the latch relay may include detecting an overvoltage or an undervoltage of the battery based on the reference voltage and a voltage of the battery.

According to an embodiment, the controlling of the latch relay may include determining, by the controller, a converted voltage corresponding to an amount of discharge current of the battery and detecting, by the controller, overdischarge of the battery based on the reference voltage and the converted voltage.

According to an embodiment, the controlling of the latch relay may include determining, by the controller, a converted voltage corresponding to an amount of charge current of the battery and detecting, by the controller, overcharge of the battery based on the reference voltage and the converted voltage.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a block diagram illustrating a battery protection system for a vehicle according to an embodiment of the present disclosure;

FIG. 2 is a block diagram of an apparatus for protecting a vehicle battery according to an embodiment of the present disclosure;

FIG. 3 is a diagram illustrating a detailed configuration of a controller provided in an apparatus for protecting a vehicle battery according to an embodiment of the present disclosure;

FIG. 4 is a diagram illustrating the operation of an overvoltage detector and an undervoltage detector in a controller provided in an apparatus for protecting a vehicle battery according to an embodiment of the present disclosure;

FIG. 5 is a diagram illustrating the operation of an overdischarge detector and an overcharge detector in a controller provided in an apparatus for protecting a vehicle battery according to an embodiment of the present disclosure;

FIG. 6 is a flowchart illustrating a method of protecting a vehicle battery according to an embodiment of the present disclosure;

FIG. 7 is a flowchart illustrating a method of protecting a vehicle battery according to another embodiment of the present disclosure; and

FIG. 8 is a block diagram illustrating a computing system for executing a method of protecting a vehicle battery according to each embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when it is displayed on other drawings. Further, in describing the embodiments of the present disclosure, a detailed description of the related known configuration or function will be omitted when it is determined that it interferes with the understanding of the embodiments of the present disclosure.

In addition, terms such as first, second, A, B, (a), (b), or the like may be used herein when describing components of embodiments of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies and should not be construed as ideal or excessively formal meanings unless clearly defined in the specification of the present disclosure.

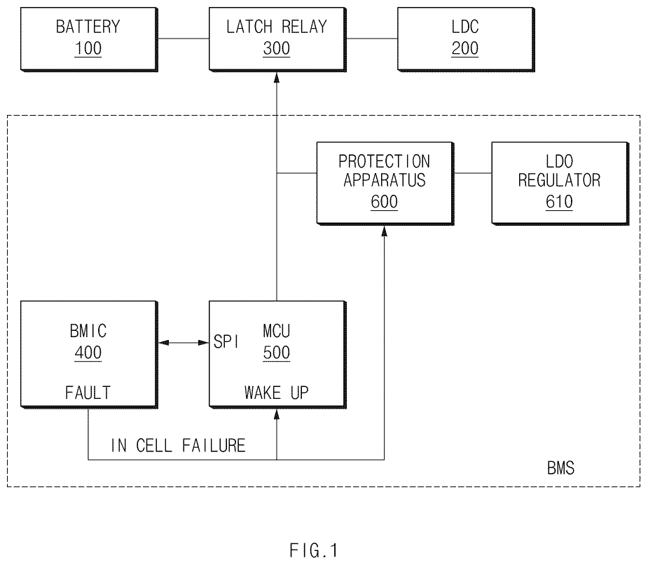

FIG. 1 is a block diagram illustrating a battery protection system for a vehicle according to an embodiment of the present disclosure.

As shown in FIG. 1, a battery protection system for a vehicle according to an embodiment of the present disclosure may include a battery 100, a low voltage DC-DC converter (LDC) 200, a latch relay 300, and a battery monitoring IC (BMIC) 400, a micro controller unit (MCU) 500, a protection apparatus 600, and a low dropout (LDO) regulator 610. In this case, depending on a scheme of implementing the battery protection system for a vehicle according to an embodiment of the present disclosure, components may be combined with each other to be implemented as one, or some components may be omitted.

In this case, the latch relay 300 may be located on a line that electrically connects the battery 100 and the LDC 200 and may maintain or block the electrical connection between the battery 100 and the LDC 200.

When a failure occurs in the battery 100, the BMIC 400 may transmit a fault signal to the MCU 500 and the protection apparatus 600.

The MCU 500 may receive a fault signal from the BMIC 400, determine a failure type of the battery 100 based on serial peripheral interface (SPI) communication with the BMIC 400, and turn off the latch relay 300 to protect the battery 100 (that is, blocking the electrical connection between the battery 100 and the LDC 200).

The protection apparatus 600 may be activated by the voltage input to the latch relay 300 and the voltage output from the latch relay 300 and may detect a failure of the battery 100 based on a reference voltage (for example, 5 V) output from the LDO regulator 610. In this case, the failure of the battery 100 may include at least one of overvoltage, undervoltage, overdischarge, and overcharge.

In this case, the protection apparatus 600 may detect overvoltage or undervoltage of the battery 100 based on the reference voltage and the voltage of the battery 100.

In addition, the protection apparatus 600 may determine a converted voltage corresponding to the amount of discharge current of the battery 100 and detect overdischarge of the battery 100 based on the reference voltage and the converted voltage.

In addition, the protection apparatus 600 may determine a converted voltage corresponding to the charging current amount of the battery 100 and detect overcharging of the battery 100 based on the reference voltage and the converted voltage.

Meanwhile, the protection apparatus 600 may be activated by a fault signal output from the BMIC 400 provided in a vehicle and may detect a failure of the battery based on the reference voltage output from the LDO regulator 610.

In this case, the protection apparatus 600 may detect overvoltage or undervoltage of the battery 100 based on the reference voltage and the voltage of the battery 100.

In addition, the protection apparatus 600 may determine a converted voltage corresponding to the amount of discharge current of the battery 100 and detect overdischarge of the battery 100 based on the reference voltage and the converted voltage.

In addition, the protection apparatus 600 may determine a converted voltage corresponding to the amount of charge current of the battery 100 and detect an overcharge of the battery 100 based on the reference voltage and the converted voltage.

The LDO regulator 610, which is a regulator that operates even at low input and output potential differences, may be implemented with an amplifier and a pass transistor and may generate a reference voltage of 5V, for example.

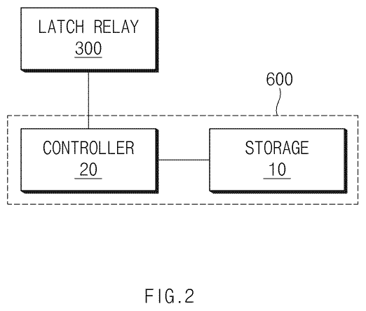

FIG. 2 is a block diagram of an apparatus for protecting a vehicle battery according to an embodiment of the present disclosure.

As shown in FIG. 2, the protection apparatus 600 for protecting a vehicle battery according to an embodiment of the present disclosure may include storage 10 and a controller 20. In this case, depending on a scheme of implementing the protection apparatus 600 for protecting a vehicle battery according to an embodiment of the present disclosure, components may be combined with each other to be implemented as one, or some components may be omitted.

Regarding each component, the storage 10 may store various logic, algorithms, and programs required in the processes of being activated by a voltage input to the latch relay 300 and a voltage output from the latch relay 300 and detecting a failure of the battery 100 based on a reference voltage (e.g., 5 V) output from the LDO regulator 610.

The storage 10 may store various logic, algorithms, and programs required in the processes of being activated by the voltage input to the latch relay 300 and the voltage output from the latch relay 300 and detecting an overvoltage or an undervoltage of the battery 100 based on the voltage of the battery 100 and a reference voltage (e.g., 5 V) output from the LDO regulator 610.

The storage 10 may store various logic, algorithms, and programs required in the processes of being activated by the voltage input to the latch relay 300 and the voltage output from the latch relay 300, determining a converted voltage corresponding to an amount of discharge current of the battery 100, and detecting overdischarge of the battery 100 based on the converted voltage and the reference voltage output from the LDO regulator 610.

The storage 10 may store various logic, algorithms, and programs required in the processes of being activated by the voltage input to the latch relay 300 and the voltage output from the latch relay 300, determining a converted voltage corresponding to an amount of charge current of the battery 100, and detecting overcharge of the battery 100 based on the converted voltage and the reference voltage output from the LDO regulator 610.

The storage 10 may store various logic, algorithms, and programs required in the processes of being activated by a fault signal output from the BMIC 400 and detecting a failure of the battery 100 based on the reference voltage output from the LDO regulator 610.

The storage 10 may store various logic, algorithms, and programs required in the processes of being activated by a fault signal output from the BMIC 400 and detecting an overvoltage or an undervoltage of the battery 100 based on the voltage of the battery 100 and the reference voltage output from the LDO regulator 610.

The storage 10 may store various logic, algorithms, and programs required in the processes of being activated by the fault signal output from the BMIC 400, determining the converted voltage corresponding to the amount of discharge current of the battery 100, and detecting an overdischarge of the battery 100 based on the converted voltage and the reference voltage output from the LDO regulator 610.

The storage 10 may store various logic, algorithms, and programs required in the processes of being activated by the fault signal output from the BMIC 400, determining the converted voltage corresponding to the amount of charge current of the battery 100, and detecting an overcharge of the battery 100 based on the converted voltage and the reference voltage output from the LDO regulator 610.

The controller 20 may be electrically connected to each component and may perform overall control such that each component performs its function. The controller 20 may be implemented in the form of hardware or software, or it may be implemented in a combination of hardware and software. Preferably, the controller 20 may be implemented as a microprocessor, but it is not limited thereto.

The controller 20 may be activated by the voltage input to the latch relay 300 and the voltage output from the latch relay 300 and may detect a failure of the battery 100 based on the reference voltage (e.g., 5 V) output from the LDO regulator 610.

In this case, the controller 20 may detect overvoltage or undervoltage of the battery 100 based on the reference voltage and the voltage of the battery 100.

In addition, the controller 20 may determine the converted voltage corresponding to the amount of discharge current of the battery 100 and detect overdischarge of the battery 100 based on the reference voltage and the converted voltage.

In addition, the controller 20 may determine the converted voltage corresponding to the amount of charge current of the battery 100 and detect overcharge of the battery 100 based on the reference voltage and the converted voltage.

Meanwhile, the controller 20 may be activated by the fault signal output from the BMIC 400 provided in the vehicle and detect a failure of the battery 100 based on the reference voltage output from the LDO regulator 610.

In this case, the controller 20 may detect overvoltage or undervoltage of the battery 100 based on the reference voltage and the voltage of the battery 100.

In addition, the controller 20 may determine the converted voltage corresponding to the amount of discharge current of the battery 100 and detect overdischarge of the battery 100 based on the reference voltage and the converted voltage.

In addition, the controller 20 may determine the converted voltage corresponding to the amount of charge current of the battery 100 and detect overcharging of the battery 100 based on the reference voltage and the converted voltage.

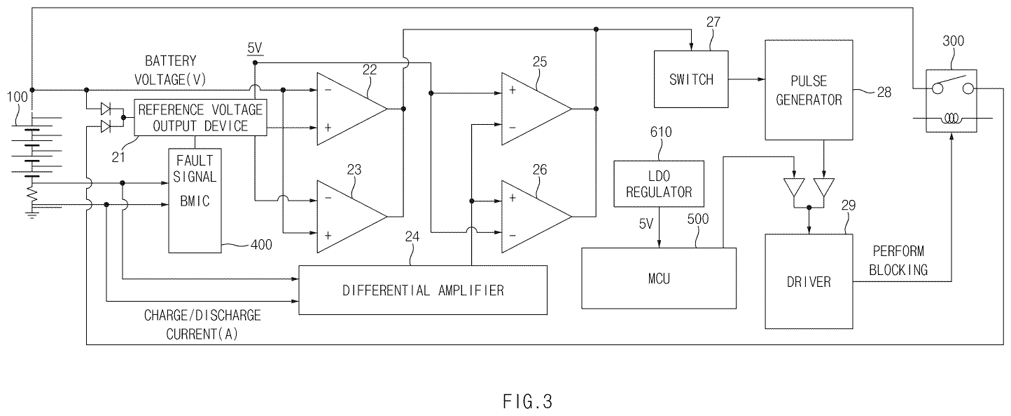

Hereinafter, the detailed configuration of the controller 20 will be described with reference to FIGS. 3 to 5.

FIG. 3 is a diagram illustrating a detailed configuration of a controller provided in an apparatus for protecting a vehicle battery according to an embodiment of the present disclosure.

As shown in FIG. 3, the controller 20 provided in an apparatus for protecting a vehicle battery according to an embodiment of the present disclosure may include a reference voltage output device 21, an overvoltage detector 22, an undervoltage detector 23, a differential amplifier 24, an overdischarge detector 25, an overcharge detector 26, a switch 27, a pulse generator 28, and a driver 29.

The reference voltage output device 21 may be activated by the voltage input to the latch relay 300 and the voltage output from the latch relay 300, or it may be activated by the fault signal output from the BMIC 400. The reference voltage output device 21 activated in such a manner may output the reference voltage (e.g., 5 V) from the LDO regulator 610. In this case, the reference voltage output device 21 may be implemented as a combination of an NPN transistor (TR) and a PNP TR, for example.

The overvoltage detector 22 may be implemented as an operational amplifier (OP Amp) comparator, and it may be determined as an overvoltage when the voltage of the battery 100 exceeds the maximum threshold voltage (e.g., 14.6 V).

The undervoltage detector 23 may be implemented as an OP Amp comparator, and it may be determined as an undervoltage when the voltage of the battery 100 is less than the minimum threshold voltage (e.g., 10 V).

The differential amplifier 24, which is a bidirectional differential amplifier, may determine the converted voltage corresponding to the amount of discharge current of the battery 100 or the converted voltage corresponding to the amount of charge current of the battery 100.

For example, the differential amplifier 24 may determine the converted voltage V₁ corresponding to the amount of discharge current based on the following Equation 1 and determine the converted voltage V₂ corresponding to the amount of charge current based on the following Equation 2.

$${V}_{1} = ( {R}_{s h u n t} \times {I}_{d i s c h a r g e} \times {ω}_{1} ) + {V}_{r} \qquad Equation 1$$

Where Rₛₕᵤₙₜ represents a shunt resistance (e.g., 0.1 mΩ), I_{discharge} represents an amount of discharge current, ω₁ represents a gain (e.g., 50 V/V), and Vᵣ represents an offset voltage (e.g., 2.5 V).

$${V}_{2} = ( {R}_{s h u n t} \times - {I}_{c h a r g e} \times {ω}_{1} ) + {V}_{r} \qquad Equation 2$$

Where Rₛₕᵤₙₜ represents a shunt resistance (e.g., 0.1 mΩ), I_{charge} represents an amount of charge current, ω₁ represents a gain (e.g., 50 V/V), and Vᵣ represents an offset voltage (e.g., 2.5 V).

The overdischarge detector 25 may be implemented with an OP Amp comparator, and it may determine an overdischarge when the discharge amount of the battery 100 exceeds a threshold discharge amount (e.g., 194 A).

The overcharge detector 26 may be implemented with an OP Amp comparator, and it may determine an overcharge when the charge amount of the battery 100 exceeds a threshold charge amount (e.g., 191 A).

The switch 27 may be implemented with a PNP TR. The switch 27 may be turned on to generate a high signal when the overvoltage detector 22 detects the overvoltage of the battery 100, when the undervoltage detector 23 detects the undervoltage voltage of the battery 100, when the overdischarge detector 25 detects the overdischarge of the battery 100, or when the overcharge detector 26 detects the overcharge of the battery 100. That is, when the switch 27 receives a low signal, the switch 27 may be turned on to output a high signal.

The pulse generator 28 may be implemented in the form of a one-shot trigger circuit, and it may generate a pulse (i.e., a high pulse) for a preset time (e.g., 50 ms). For reference, when the coil of the latch relay 300 is excited for more than 1 minute, the latch relay 300 may be damaged.

The driver 29, which is a low-side driver, is driven for a preset time (e.g., 50 ms) to turn off the latch relay 300. Accordingly, charging and discharging of the battery 100 is immediately stopped.

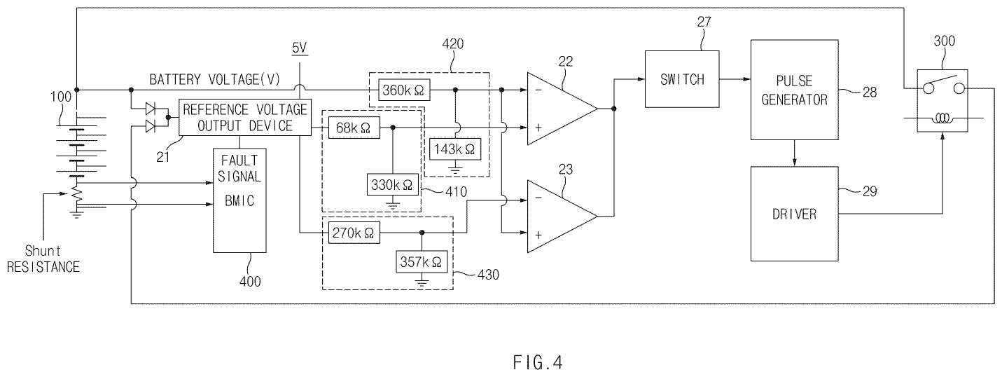

FIG. 4 is a diagram illustrating the operation of an overvoltage detector and an undervoltage detector in a controller provided in an apparatus for protecting a vehicle battery according to an embodiment of the present disclosure.

First, a first divider 410 may distribute the reference voltage of 5 V output from the reference voltage output device 21 according to the voltage distribution law between the resistance of 68 kΩ and the resistance of 330 kΩ. The reference voltage distributed in such a manner and input to the positive (+) terminal of the overvoltage detector 22 is 4.146 V.

A second divider 420 may distribute the voltage of 14.6 V of the battery 100 according to the voltage distribution law between a resistance of 360 kΩ and a resistance of 143 kΩ. The voltage of the battery 100 distributed in such a manner and input to the negative (−) terminal of the overvoltage detector 22 is 4.151 V.

Because the voltage of the battery 100 is 4.151 V, which is higher than the reference voltage of 4.146 V, the overvoltage detector 22 may determine the voltage state of the battery 100 as an overvoltage state. In this case, the overvoltage detector 22 may output a low signal because the input value (4.151 V) of the negative terminal is greater than the input value (4.146 V) of the positive terminal, and the low signal may allow the switch 27 to be switched from an off state to an on state.

Meanwhile, a third divider 430 may distribute the reference voltage of 5 V output from the reference voltage output device 21 according to the voltage distribution law between the resistance of 270 kΩ and the resistance of 357 kΩ. The reference voltage distributed in such a manner and input to the negative (−) terminal of the undervoltage detector 23 is 2.847 V.

The second divider 420 may distribute the voltage of 10 V of the battery 100 according to the voltage distribution law between a resistance of 360 kΩ and a resistance of 143 kΩ. The voltage of the battery 100 distributed in such a manner and input to the positive (+) terminal of the undervoltage detector 23 is 2.843 V.

Because the voltage of the battery 100 is 2.843 V, which is lower than the reference voltage of 2.847 V, the undervoltage detector 23 may determine the voltage state of the battery 100 to be an undervoltage state. In this case, the undervoltage detector 23 may output a low signal because the input value (2.847 V) of the negative terminal is greater than the input value (2.843 V) of the positive terminal, and the low signal may allow the switch 27 to be switched from the off state to the on state.

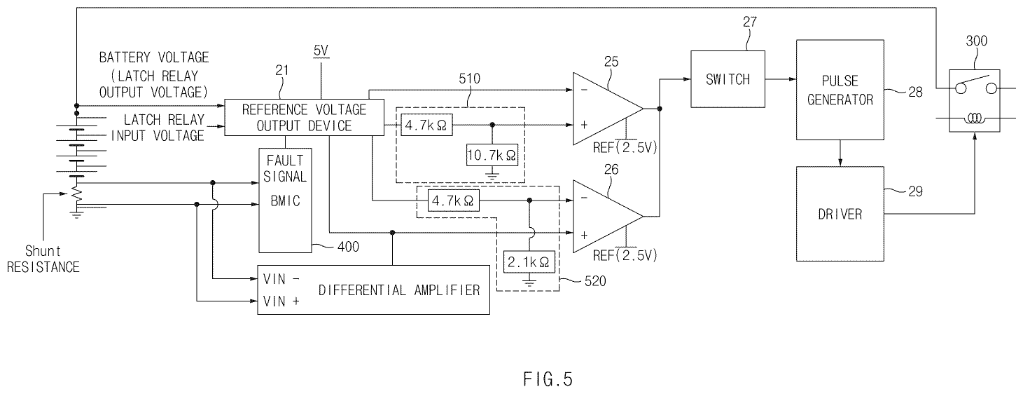

FIG. 5 is a diagram illustrating the operation of an overdischarge detector and an overcharge detector in a controller provided in an apparatus for protecting a vehicle battery according to an embodiment of the present disclosure.

First, when the discharge current of the battery 100 is 194 A, the differential amplifier 24 may output 3.47 V as the voltage of the battery 100 based on Equation 1 above. The voltage of 3.47 V of the battery 100 output in such a manner is input to the negative (−) terminal of the overdischarge detector 25.

A fourth divider 510 may distribute the reference voltage of 5 V output from the reference voltage output device 21 according to the voltage distribution law between the resistance of 4.7 kΩ and the resistance of 10.7 kΩ. The reference voltage distributed in such a manner and input to the positive (+) terminal of the overdischarge detector 25 is 3.474 V.

In this case, when the amount of discharge current of the battery 100 is 194 A (i.e., when the amount of discharge current of the battery 100 is at an appropriate level), the overdischarge detector 25 does not output the low signal because the input value (3.47 V) of the negative terminal is smaller than the input value (3.474 V) of the positive terminal. Accordingly, the switch 27 is maintained in the off state.

However, when the amount of discharge current of the battery 100 is 195 A, which is greater than 194 A (i.e., when the amount of discharge current of the battery 100 exceeds an appropriate level), the voltage of the battery 100 output from the differential amplifier 24 is 3.475 V. Because the input value (3.475 V) of the negative terminal is greater than the input value (3.47 V) of the positive terminal, the overdischarge detector 25 may output a low signal, and the low signal may allow the switch 27 to be switched from the off state to the on state.

Meanwhile, when the charge current of the battery 100 is 192 A, the differential amplifier 24 may output 1.54 V, which is a voltage of the battery 100, based on Equation 2. The voltage of 1.54 V of the battery 100 output in this way is input to the positive (+) terminal of the overcharge detector 26.

A fifth divider 520 may distribute the reference voltage of 5 V output from the reference voltage output device 21 according to the voltage distribution law between the resistance of 4.7 kΩ and the resistance of 2.1 kΩ. The reference voltage distributed in such a manner and input to the negative (−) terminal of the overcharge detector 26 is 1.544 V.

In this case, because the input value (1.544 V) of the negative terminal is greater than the input value (1.54 V) of the positive terminal when the amount of charge current of the battery 100 is 192 A (i.e., when the amount of charge current of the battery 100 exceeds an appropriate level), the overcharge detector 26 may output a low signal, and the low signal may allow the switch 27 to be switched from the off state to the on state.

However, when the charge current of the battery 100 is 191 A, which is less than 192 A (i.e., when the charge current of the battery 100 is at an appropriate level), the voltage of the battery 100 output from the differential amplifier 24 is 1.545 V. The overcharge detector 26 does not output a low signal because the input value (1.544 V) of the negative terminal is not greater than the input value (1.545 V) of the positive terminal. Accordingly, the switch 27 is maintained in the off state.

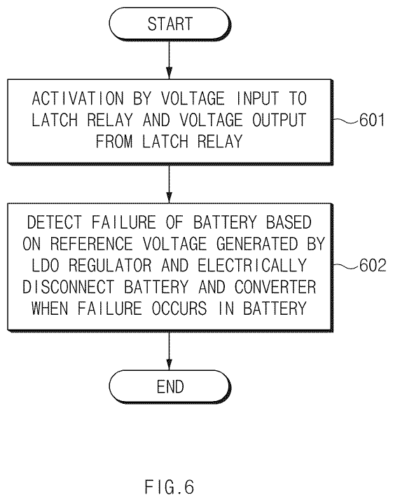

FIG. 6 is a flowchart illustrating a method of protecting a vehicle battery according to an embodiment of the present disclosure.

First, in 601, the controller 20 is activated by the voltage input to the latch relay 300 and the voltage output from the latch relay 300.

Thereafter, in 602, the controller 20 detects a failure of the battery 100 based on the reference voltage generated by the LDO regulator 610, and when the failure occurs in the battery 100, controls the latch relay 300 to electrically disconnect the battery 100 and the LDC 200.

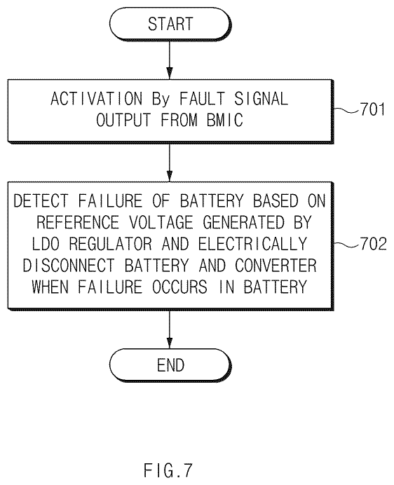

FIG. 7 is a flowchart illustrating a method of protecting a vehicle battery according to another embodiment of the present disclosure.

First, in 701, the controller 20 is activated by the fault signal output from the BMIC 400.

Thereafter, in 702, the controller 20 detects a failure of the battery 100 based on the reference voltage generated by the LDO regulator 610, and when the failure occurs in the battery 100, controls the latch relay 300 to electrically disconnect the battery 100 and the LDC 200.

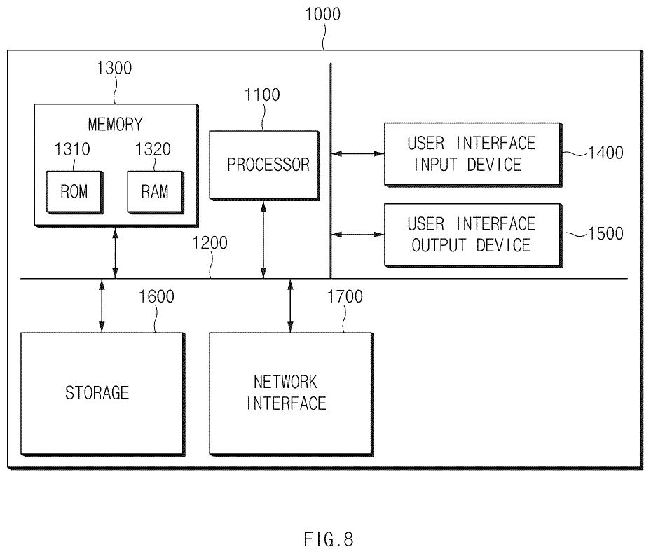

FIG. 8 is a block diagram illustrating a computing system for executing a method of protecting a vehicle battery according to each embodiment of the present disclosure.

Referring to FIG. 8, a method of protecting a vehicle battery according to an embodiment of the present disclosure described above may be implemented through a computing system 1000. The computing system 1000 may include at least one processor 1100, a memory 1300, a user interface input device 1400, a user interface output device 1500, a storage (i.e., a memory) 1600, and a network interface 1700 connected through a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, a solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

According to the embodiments of the present disclosure, the apparatus for protecting a vehicle battery may include a latch relay that electrically connects or disconnects the vehicle battery and the LDC, may be activated by the voltage input to the latch relay and the voltage output from the latch relay, and may detect a failure of the battery based on a reference voltage output from the LDO regulator, such that the apparatus may monitor the state of the battery even when the BMIC or MCU provided in the vehicle is in a sleep state and may turn off the latch relay when a failure occurs in the battery.

Although exemplary embodiments of the present disclosure have been described for illustrative purposes, those skilled in the art will appreciate that various modifications, additions, and substitutions are possible, without departing from the scope and spirit of the disclosure. Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. An apparatus for protecting a battery of a vehicle, the apparatus comprising:
a latch relay configured to electrically connect or disconnect the battery and a converter in the vehicle; and
a controller configured to be activated by a voltage input to the latch relay and a voltage output from the latch relay, detect a failure of the battery based on a reference voltage generated by a low dropout regulator, and control the latch relay to electrically disconnect the battery and the converter in response to detection of the failure of the battery.

2. The apparatus of claim 1, wherein the controller is configured to detect an overvoltage or an undervoltage of the battery based on the reference voltage and a voltage of the battery.

3. The apparatus of claim 2, wherein the controller comprises:
a reference voltage output device configured to be activated by the voltage input to the latch relay and the voltage output from the latch relay and to output the reference voltage;
a divider configured to distribute a portion of the reference voltage as a first reference voltage;
an overvoltage detector configured to compare the first reference voltage and the voltage of the battery and to output a low signal in a case in which the voltage of the battery is higher than the first reference voltage;
a switch configured to be turned on by the low signal to output a high signal;
a pulse generator configured to generate a high pulse for a first preset time; and
a driver configured to be driven for a second preset time to turn off the latch relay.

4. The apparatus of claim 2, wherein the controller comprises:
a reference voltage output device configured to be activated by the voltage input to the latch relay and the voltage output from the latch relay and to output the reference voltage;
a divider configured to distribute a portion of the reference voltage as a first reference voltage;
an undervoltage detector configured to compare the first reference voltage and the voltage of the battery and to output a low signal in a case in which the voltage of the battery is lower than the first reference voltage;
a switch configured to be turned on by the low signal to output a high signal;
a pulse generator configured to receive the high signal to generate a high pulse for a first preset time; and
a driver configured to be driven for a second preset time to turn off the latch relay.

5. The apparatus of claim 1, wherein the controller is configured to determine a converted voltage corresponding to an amount of discharge current of the battery and to detect an overdischarge of the battery based on the reference voltage and the converted voltage.

6. The apparatus of claim 5, wherein the controller comprises:
a reference voltage output device configured to be activated by the voltage input to the latch relay and the voltage output from the latch relay and to output the reference voltage;
a divider configured to distribute a portion of the reference voltage as a first reference voltage;
a differential amplifier configured to determine the converted voltage corresponding to the amount of the discharge current of the battery;
an overdischarge detector configured to compare the first reference voltage and the converted voltage and to output a low signal in a case in which the converted voltage is greater than the first reference voltage;
a switch configured to be turned on by the low signal to output a high signal;
a pulse generator configured to receive the high signal to generate a high pulse for a first preset time; and
a driver configured to be driven for a second preset time to turn off the latch relay.

7. The apparatus of claim 1, wherein the controller is configured to determine a converted voltage corresponding to an amount of charge current of the battery and to detect an overcharge of the battery based on the reference voltage and the converted voltage.

8. The apparatus of claim 7, wherein the controller comprises:
a reference voltage output device configured to be activated by the voltage input to the latch relay and the voltage output from the latch relay and to output the reference voltage;
a divider configured to distribute a portion of the reference voltage as a first reference voltage;
a differential amplifier configured to determine the converted voltage corresponding to the amount of the charge current of the battery;
an overcharge detector configured to compare the first reference voltage and the converted voltage and to output a low signal in a case in which the converted voltage is lower than the first reference voltage;
a switch configured to be turned on by the low signal to output a high signal;
a pulse generator configured to receive the high signal to generate a high pulse for a first preset time; and
a driver configured to be driven for a second preset time to turn off the latch relay.

9. An apparatus for protecting a battery of a vehicle, the apparatus comprising:
a latch relay configured to electrically connect or disconnect the battery and a converter in the vehicle; and
a controller configured to be activated by a fault signal output from a battery monitoring integrated circuit, detect a failure of the battery based on a reference voltage generated by a low dropout regulator, and control the latch relay to electrically disconnect the battery and the converter in response to a detection of the failure of the battery.

10. The apparatus of claim 9, wherein the controller is configured to detect an overvoltage or an undervoltage of the battery based on the reference voltage and a voltage of the battery.

11. The apparatus of claim 10, wherein the controller comprises:
a reference voltage output device configured to be activated by a voltage input to the latch relay and a voltage output from the latch relay and to output the reference voltage;
a divider configured to distribute a portion of the reference voltage as a first reference voltage;
an overvoltage detector configured to compare the first reference voltage and the voltage of the battery and to output a low signal in a case in which the voltage of the battery is higher than the first reference voltage;
a switch configured to be turned on by the low signal to output a high signal;
a pulse generator configured to generate a high pulse for a first preset time; and
a driver configured to be driven for a second preset time to turn off the latch relay.

12. The apparatus of claim 10, wherein the controller comprises:
a reference voltage output device configured to be activated by a voltage input to the latch relay and a voltage output from the latch relay and to output the reference voltage;
a divider configured to distribute a portion of the reference voltage as a first reference voltage;
an undervoltage detector configured to compare the first reference voltage and the voltage of the battery and to output a low signal in a case in which the voltage of the battery is lower than the first reference voltage;
a switch configured to be turned on by the low signal to output a high signal;
a pulse generator configured to receive the high signal to generate a high pulse for a first preset time; and
a driver configured to be driven for a second preset time to turn off the latch relay.

13. The apparatus of claim 9, wherein the controller is configured to determine a converted voltage corresponding to an amount of discharge current of the battery and to detect an overdischarge of the battery based on the reference voltage and the converted voltage.

14. The apparatus of claim 13, wherein the controller comprises:
a reference voltage output device configured to be activated by a voltage input to the latch relay and a voltage output from the latch relay and to output the reference voltage;
a divider configured to distribute a portion of the reference voltage as a first reference voltage;
a differential amplifier configured to determine the converted voltage corresponding to the amount of the discharge current of the battery;
an overdischarge detector configured to compare the first reference voltage and the converted voltage and to output a low signal in a case in which the converted voltage is greater than the first reference voltage;
a switch configured to be turned on by the low signal to output a high signal;
a pulse generator configured to receive the high signal to generate a high pulse for a first preset time; and
a driver configured to be driven for a second preset time to turn off the latch relay.

15. The apparatus of claim 9, wherein the controller is configured to determine a converted voltage corresponding to an amount of charge current of the battery and to detect an overcharge of the battery based on the reference voltage and the converted voltage.

16. The apparatus of claim 15, wherein the controller comprises:
a reference voltage output device configured to be activated by a voltage input to the latch relay and a voltage output from the latch relay and to output the reference voltage;
a divider configured to distribute a portion of the reference voltage as a first reference voltage;
a differential amplifier configured to determine the converted voltage corresponding to the amount of the charge current of the battery;
an overcharge detector configured to compare the first reference voltage and the converted voltage and to output a low signal in a case in which the converted voltage is lower than the first reference voltage;
a switch configured to be turned on by the low signal to output a high signal;
a pulse generator configured to receive the high signal to generate a high pulse for a first preset time; and
a driver configured to be driven for a second preset time to turn off the latch relay.

17. A method of protecting a battery of a vehicle, the method comprising:
activating a controller by a voltage input to a latch relay and a voltage output from the latch relay or by a fault signal output from a battery monitoring integrated circuit;
detecting, by the controller, a failure of the battery based on a reference voltage generated by a low dropout regulator; and
controlling the latch relay to electrically disconnect the battery and a converter in response to detecting the failure of the battery.

18. The method of claim 17, wherein controlling the latch relay comprises detecting an overvoltage or an undervoltage of the battery based on the reference voltage and a voltage of the battery.

19. The method of claim 17, wherein controlling the latch relay comprises:
determining, by the controller, a converted voltage corresponding to an amount of discharge current of the battery; and
detecting, by the controller, an overdischarge of the battery based on the reference voltage and the converted voltage.

20. The method of claim 17, wherein controlling the latch relay comprises:
determining, by the controller, a converted voltage corresponding to an amount of charge current of the battery; and
detecting, by the controller, an overcharge of the battery based on the reference voltage and the converted voltage.
